(19) United States
(12) Patent Application Publication
(10) Pub. No.: US 2009/0190336 A1
(43) Pub. Date: Jul. 30, 2009

(54) Lighting apparatus having separate control panel

(75) Inventors: Kuo-Hsin Teng, Taipei (TW); Hon-Lun Chen, Taipei (TW)

Correspondence Address: REED SMITH LLP, Suite 1400, 3110 Fairview Park Drive, Falls Church, VA, 22042, US

(73) Assignee: PRODISC TECHNOLOGY INC.

(21) Appl. No.: 12/076,321

(22) Filed: Mar. 17, 2008

(30) Foreign Application Priority Data
Jan. 25, 2008 (TW) 097201681

(51) Int. Cl. F21V 33/00

(52) U.S. Cl. 362/154

(57) ABSTRACT

A lighting apparatus having a separate control panel comprises a lamp holder and a light source module that is settled in the lamp holder. The light source module is electrically connected to the control panel through a set of wires and the control panel is settled separately from the lamp holder. Thereby, the lighting apparatus can be sized without consideration for dimensions of the control panel and therefore the lighting apparatus can be efficiently reduced in its thickness and weight.

### BACKGROUND OF THE INVENTION

1. Technical Field

The present invention relates to a lighting apparatus having a separate control panel, and more particularly, to a lighting apparatus having a control panel that can be settled separately therefrom.

2. Description of Related Art

With the improvement of people's living standard, more and more attention has been paid to the domestic living environment and therefore home decorations are getting more and more popular. Under such circumstances, aquariums may be one kind of the most popular decorations. The simulated terrain and changeable lighting of an aquarium can provide diverse visual effects thereby not only adorning the ambient environment but also teaching while entertaining the viewers with the aquatic ecology therein.

Recently, in view of the trend toward power saving, the conventional lighting sources have tended to be replaced by light-emitting diode modules. A light-emitting diode module is advantageous in reducing not only the thickness but also the weight of a lighting apparatus using it. However, in practice, a lighting apparatus is nevertheless subject to the volume of a control panel settled in the lamp holder thereof when being sized and therefore dimensional reduction of the conventional lighting apparatus is limited.

FIG. 1 is a lateral view of a conventional lighting apparatus 10. Therein, a control panel 11 is typically deposited in a lamp holder 12 thereof Since the control panel 11 takes a significant area in the lamp holder 12, it can in turn substantially increase the volume and weight of the lighting apparatus 10. In addition, when such lighting apparatus 10 equipped with the integrated control panel 11 is to be installed on an aquarium 20, sufficient installation space is necessary, and thus such lighting apparatus 10 is inconvenient for users to apply.

Furthermore, for providing the aquatics in the aquarium with appropriate living environment, the lighting apparatus 10 usually has to be periodically turned on/off so as to simulate the natural illumination in day and night. However, it would be a trouble and inconvenience for a user to manually turn on/off the lighting apparatus 10 twice a day.

### SUMMARY OF THE INVENTION

The present invention discloses a lighting apparatus having a separate control panel. By separately setting the control panel and a lamp holder of the lighting apparatus, a thickness of the lamp holder can be freely designed without consideration for dimensions of the control panel so that a thickness and a weight of the overall lighting apparatus can be efficiently reduced.

To achieve the aforementioned objective, the disclosed lighting apparatus having the separate control panel comprises a lamp holder and a light source module that settled in the lamp holder, and is characterized by that the light source module is electrically connected to the control panel through a set of wires and the control panel is settled separately from the lamp holder.

Therein, the light source module may be a light-emitting diode light source module. The wires may be a set of signal wires or may comprise a set of signal wires and a set of power cords. The control panel may be a remote control panel. Furthermore, the control panel may have a hook unit, a sucker unit or an adhesive unit. The lighting apparatus may further include a timer that is connected to the control panel through an interface or a connector, or is integrally formed in the control panel.

By implementing the present invention, at least the following progressive effects can be achieved:
1. By separating the control panel from the lamp holder, the dimensions and the weight of the lighting apparatus can be reduced.
2. By further providing the timer that is connected to the control panel, the lighting apparatus can be scheduled to be turned on/off.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a lateral view of a conventional lighting apparatus;

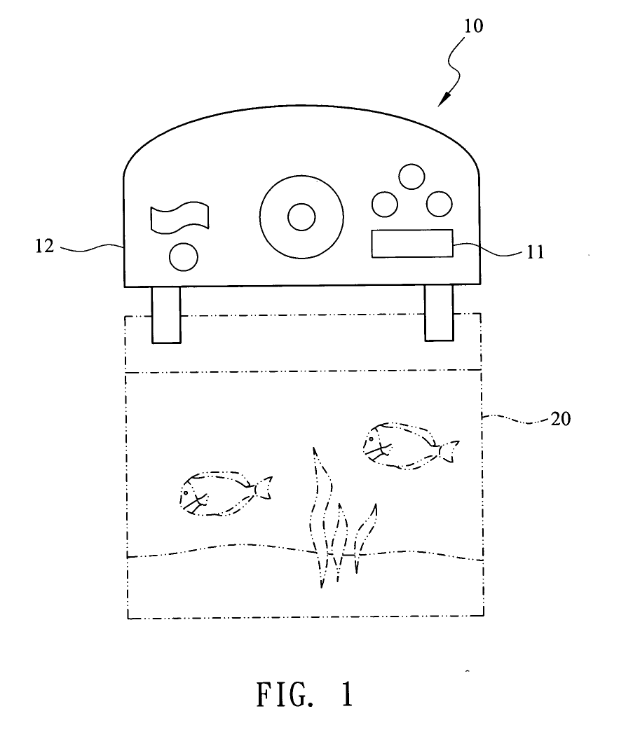

FIG. 2 is a perspective view of a lighting apparatus having a separate control panel of the present invention;

FIG. 3 is an applied view of the lighting apparatus having the separate control panel of the present invention taken from an oblique front point;

FIG. 4 is a schematic drawing of an exemplificative connection between a control panel and a timer according to the present invention; and

FIG. 5 is an applied view of the lighting apparatus having the separate control panel of the present invention taken from a lateral point.

### DETAILED DESCRIPTION OF THE PREFERRED EMBODIMENT

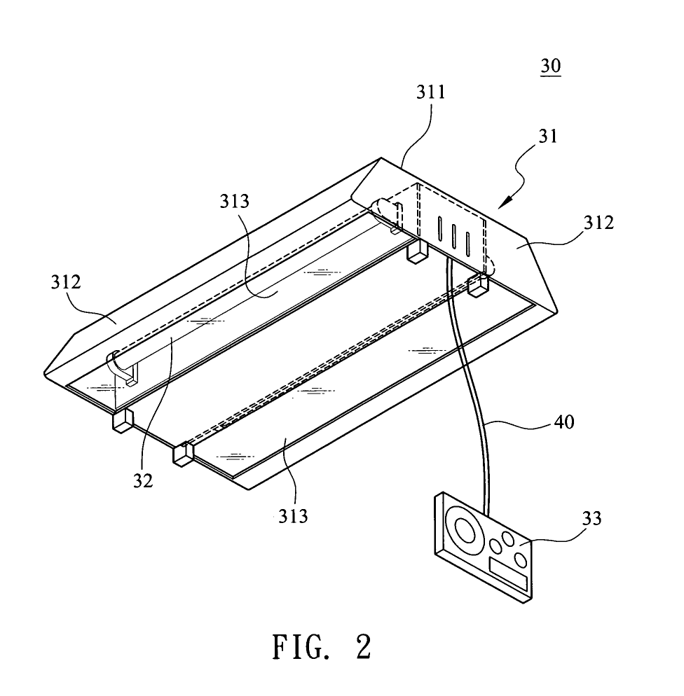

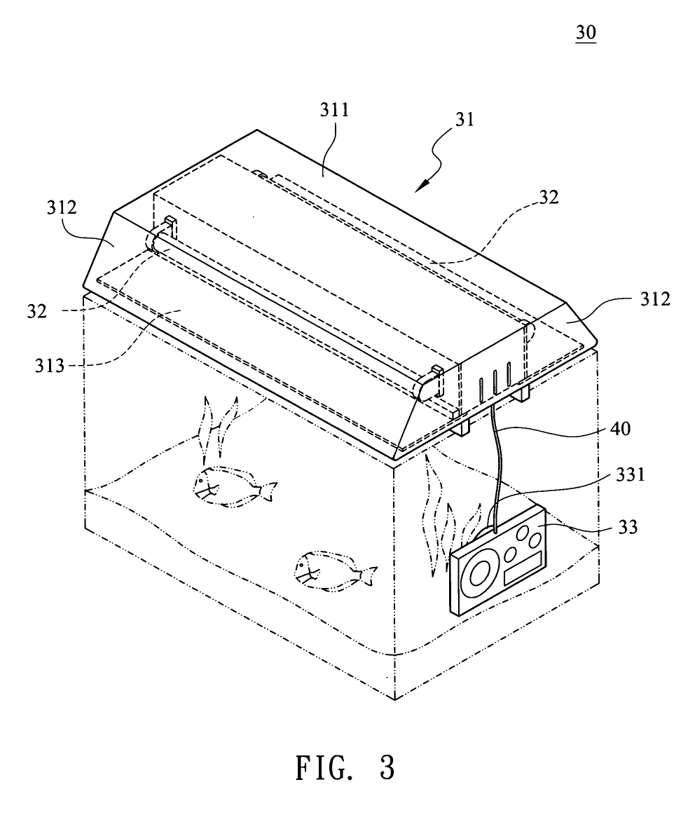

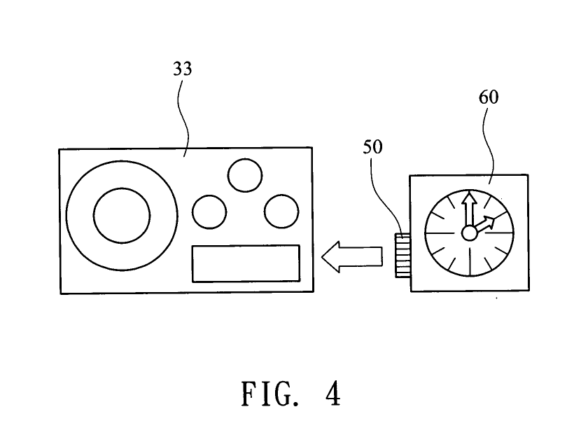

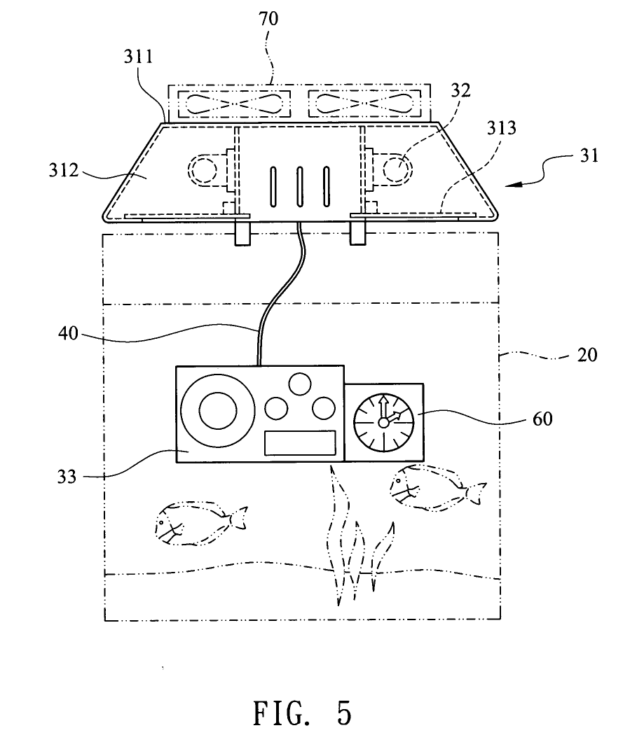

FIG. 2 is a perspective view of a lighting apparatus 30 having a separate control panel of the present invention. FIG. 3 is an applied view of the lighting apparatus 30 having the separate control panel of the present invention taken from an oblique front point. FIG. 4 is a schematic drawing of an exemplificative connection between a control panel 33 and a timer 60 according to the present invention. FIG. 5 is an applied view of the lighting apparatus 30 having the separate control panel of the present invention taken from a lateral point.

As shown in FIG. 2, the disclosed lighting apparatus 30 having a separate control panel comprises a lamp holder 31 and a light source module 32.

The lamp holder 31 may be constructed from a top board 311 and four side boards 312 combined together with an accommodating space formed therein. The light source module 32 may be a light-emitting diode module or another similar light-emitting element. The light source module 32 may be installed in the accommodating space of the lamp holder 31. Furthermore, an underside of the lamp holder 31, namely an opening corresponding to the top board 311 may be equipped with a transparent cover 313 so that a light beam emitted from the light source module 32 is allowed to pass therethrough. Meantime, the transparent cover 313 serves to protect the light source module 32 from being splashed by water coming from the aquarium 20.

The control panel 33 may be manually operated to turn on/off the light source module 32. Alternatively, the control panel 33 may be a remote control panel for being operated remotely. The control panel 33 is settled separately from the lamp holder 31 and electrically connected to the light source module 32 through a set of wires 40. The wires 40 may be a set of signal wires or may comprise a set of signal wires and a set of power cords. Through the wires 40, a control signal output by the control panel 33 can be transmitted to the light source module 32 so as to turn on/off the light source module 32.

As shown in FIG. 3, the control panel 33 may have a sucker unit 331 for affixing the control panel 33 to an external surface of the aquarium 20. Or, the control panel 33 may have a hook unit (not shown), such as a hanging hook, for hanging the control panel 33 on the external surface of the aquarium 20. Alternatively, an adhesive unit (not shown) may be provided at a back of the control panel 33 for sticking the control panel 33 to the external surface of the aquarium 20.

Referring to FIGS. 4 and 5, for automatically turning on/off the light source module 32 according to a preset schedule, the control panel 33 may be further connected with a timer 60 through an interface 50 or a connector (not shown), wherein the connector for connecting the control panel 33 and the timer 60 may be one similar to that applied to a portable music player (such as an MP3 player or an ipod). Besides, the timer 60 may be integrally formed in the control panel 33 so as to reduce the overall volume of the control panel 33.

Thereby, a user can use the timer 60 to program a schedule for the control panel 33 to turn on/off the light source module 32 so that the light source module 32 can be turned on/off according to the schedule. Thereupon, the light source module 32 can be properly operated to simulate the illumination conditions of days and nights while the user is free from the trouble and inconvenience of manually turning on/off the lighting apparatus 30 frequently.

In FIG. 5, according to the present embodiment, not only the overall volume of the lighting apparatus 30 can be reduced, but also the design of the lighting apparatus can be more flexible. In addition, for endowing the light source module 32 with enhanced heat dissipating efficiency, a heat sink module 70, such as a fan module, a liquid cooling module or the like, may be employed to distribute the heat produced by the light source module 32 and in turn prolong the use life of the light source module 32.

Although the particular embodiment of the invention has been described in detail for purposes of illustration, it will be understood by one of ordinary skill in the art that numerous variations will be possible to the disclosed embodiments without going outside the scope of the invention as disclosed in the claims and the equivalents.

What is claimed is:

1. A lighting apparatus having a separate control panel, which comprises: a lamp holder and a light source module settled in the lamp holder and is characterized by that the light source module is electrically connected to the control panel through a set of wires and the control panel is settled separately from the lamp holder.

2. The lighting apparatus of claim 1, wherein the light source module is a light-emitting diode module.

3. The lighting apparatus of claim 1, wherein the set of wires is a set of signal wires.

4. The lighting apparatus of claim 1, wherein the set of wires includes a set of signal wires and a set of power cords.

5. The lighting apparatus of claim 1, wherein the control panel is a remote control panel.

6. The lighting apparatus of claim 1, wherein the control panel comprises a hook unit.

7. The lighting apparatus of claim 1, wherein the control panel comprises a sucker unit.

8. The lighting apparatus of claim 1, wherein the control panel comprises an adhesive unit.

9. The lighting apparatus of claim 1, further comprising a timer that is connected to the control panel through an interface.

10. The lighting apparatus of claim 1, further comprising a timer that is connected to the control panel through a connector.

11. The lighting apparatus of claim 1, further comprising a timer that is integrally formed in the control panel.
